(19) United States
(12) Patent Application Publication
(10) Pub. No.: US 2023/0144854 A1
(43) Pub. Date: May 11, 2023

(54) LABEL MANUFACTURING APPARATUS AND LABEL MANUFACTURED BY SAME LABEL MANUFACTURING APPARATUS

(71) Applicant: Kyong Do LEE, Seoul (KR)

(72) Inventor: Kyong Do LEE, Seoul (KR)

(21) Appl. No.: 17/908,776

(22) PCT Filed: Mar. 2, 2021
(86) PCT No.: PCT/KR2021/002521

§ 371 Date: Sep. 1, 2022

(30) Foreign Application Priority Data
Mar. 2, 2020 (KR) 10-2020-0026191

(51) Int. Cl. B32B 37/00; B32B 37/12; B32B 38/06; B31D 1/02; G09F 3/02

(52) U.S. Cl. CPC B32B 37/0053; B31D 1/021; B32B 37/1284; B32B 38/06; G09F 3/02; B32B 2305/18; B32B 2317/12; B32B 2405/00; B32B 2519/00; G09F 2003/0225; G09F 2003/0241; G09F 2003/0273

(57) ABSTRACT

Proposed are a label manufacturing apparatus and a label manufactured by the same label manufacturing apparatus. The label manufacturing apparatus includes a pressure-sensitive adhesive applying unit applying a pressure-sensitive adhesive onto a label fabric, a pressure-sensitive adhesive drying unit located behind the pressure-sensitive adhesive applying unit and drying the pressure-sensitive adhesive applied onto the label fabric, and a release paper attaching unit provided behind the pressure-sensitive adhesive drying unit and attaching a release paper onto the rear surface of the label fabric, wherein the release paper attaching unit is configured such that among a pair of rollers allowing the label fabric and the release paper to pass therebetween to be laminated, a roller guiding the label fabric has a concave/convex portion formed on a surface thereof so that a groove is formed on the laminated label fabric which has passed through the release paper attaching unit.

### TECHNICAL FIELD

The present disclosure relates generally to a label manufacturing apparatus and a label manufactured by the same label manufacturing apparatus. More particularly, the present disclosure relates to a label manufacturing apparatus that enables a liquid mixture for separating a PET bottle and a label to be efficiently permeated between the PET bottle and the label, thereby facilitating separation of the label from the surface of the PET bottle, and to a label manufactured by the same label manufacturing apparatus.

### BACKGROUND ART

In general, beverage products such as various drinks and bottled water are sold in a form in which a PET bottle made of polyethylene terephthalate (PET) resin, which is a synthetic resin material, is filled with a beverage. A label printed in various colors including information about the beverage, manufacturer, and expiration date are attached to the surface of the PET bottle by an adhesive.

Meanwhile, after a user purchases the beverage product and consumes all the contents, the PET bottle is collected for recycling, then subjected to a process such as label removal, and crushed to produce a crushed material for recycling.

In detail, recently, for environmental protection and recycling of resources, packaging materials such as PET bottles have been graded according to how easily the material and structure of the packaging materials can be recycled. In the case of a PET bottle, a body part is required to be colorless for easy recycling, and a label is designed to be easily removed during a recycling process.

In other words, PET bottle manufacturers manufacture colorless PET bottles without using dyes to prevent color from being added to PET bottles, and labels printed with product information are made so that they can be easily removed from the PET bottles. After removing the labels from the PET bottles collected for recycling, the colorless PET bottles are crushed into small flakes and melted to be used as raw materials for new PET bottles.

As a related art document for removing a label attached to the surface of a PET bottle collected for recycling, there is Korean Patent Application Publication No. 10-2009-0034626, entitled “Label separator for crushed material of PET bottle” (hereinafter, referred to as related art 1) and Korean Patent Application Publication No. 10-2012-0066467, entitled “Label attached to PET bottle and PET bottle recycling method” (hereinafter, referred to as related art 2).

The related art 1 has a structure in which crushed flakes of a PET bottle and crushed flakes of a label are accommodated in a rotating drum and then blown by a blower fan to separate the crushed label flakes, which are lighter than the crushed PET bottle flakes.

However, in the related art 1 having the above structure, since the crushed PET bottle flakes and the crushed label flakes are mixed in a completely separated state and the crushed label flakes, which are lighter than the crushed PET bottle flakes, are sorted by being blown by wind, there is a problem in that the label cannot be separated while the label is attached to the surface of the PET bottle.

In addition, in the related art 2, the material of a PET bottle has a specific gravity of 1.32 and a label attached to the PET bottle has a specific gravity of 0.9, and the PET bottle with the label is cut to a predetermined size, then put in a heating furnace containing a liquid mixture of water and a sodium hydroxide (NaOH) solution, and stirred to separate the PET bottle and the label.

However, in the related art 2 regarding the method as described above, since the liquid mixture has to be completely permeated between the PET bottle and the label so that the strength of an adhesive is weakened to separate the PET bottle and the label, the cut PET bottle has to be soaked in the liquid mixture for a long period of time. Therefore, there is a problem in that it takes a considerable amount of time to separate the label from the PET bottle.

### DISCLOSURE

### Technical Problem

Accordingly, the present disclosure has been made keeping in mind the above problems occurring in the related art, and an objective of the present disclosure is to provide a label manufacturing apparatus in which a fine concave/convex portion is formed on a rear surface of a label to which a pressure-sensitive adhesive is applied and only the pressure-sensitive adhesive applied to a portion where the concave/convex portion is formed is adhered to a PET bottle so that the liquid mixture for separating the PET bottle and the label is efficiently permeated between the PET bottle and the label to thereby facilitate separation of the label from the PET bottle, and to provide a label manufactured by the same label manufacturing apparatus.

### Technical Solution

In order to accomplish the above objective, according to one aspect of the present disclosure, there is provided a label manufacturing apparatus including: a pressure-sensitive adhesive applying unit configured to apply a pressure-sensitive adhesive onto a rear surface of a label fabric; a pressure-sensitive adhesive drying unit located behind the pressure-sensitive adhesive applying unit and configured to dry the pressure-sensitive adhesive applied onto the rear surface of the label fabric; and a release paper attaching unit provided behind the pressure-sensitive adhesive drying unit and configured to attach a release paper onto the rear surface of the label fabric, wherein the release paper attaching unit may be configured such that among a pair of rollers configured to allow the label fabric and the release paper to pass therebetween to be laminated, a roller configured to guide the label fabric has a concave/convex portion formed on a surface thereof so that a groove is formed on the laminated label fabric which has passed through the release paper attaching unit.

Here, wherein the release paper attaching unit may include: a first roller configured to guide the label fabric; and a second roller configured to guide the release paper in a state adjacent to the first roller, wherein the first roller may have the concave/convex portion formed on a surface thereof, and the second roller may have a flat surface.

Furthermore, the concave/convex portion may include: a first slit formed along a rotating direction of the first roller; and a second slit formed along an axial direction of the first roller by crossing the first slit.

Furthermore, at least one of the first slit and the second slit may be formed in a zigzag pattern.

Meanwhile, according to another aspect of the present disclosure, there is provided a label manufactured by a label manufacturing apparatus including: a pressure-sensitive adhesive applying unit configured to apply a pressure-sensitive adhesive onto a rear surface of a label fabric; a pressure-sensitive adhesive drying unit located behind the pressure-sensitive adhesive applying unit and configured to dry the pressure-sensitive adhesive applied onto the rear surface of the label fabric; and a release paper attaching unit provided behind the pressure-sensitive adhesive drying unit and configured to attach a release paper onto the rear surface of the label fabric, wherein the release paper attaching unit is configured such that among a pair of rollers configured to allow the label fabric and the release paper to pass therebetween to be laminated, a roller configured to guide the label fabric has a concave/convex portion formed on a surface thereof so that a groove is formed on the laminated label fabric which has passed through the release paper attaching unit.

### Advantageous Effects

According to a label manufacturing apparatus according to the present disclosure having the above-described configuration and a label manufacture by the label manufacturing apparatus, a groove is formed in a label fabric in the process of laminating the label fabric with a release paper, so that it is possible to control the degree to which the label fabric is adhered to the surface of the PET bottle by a pressure-sensitive adhesive. Furthermore, when the PET bottle collected for label separation is put in a liquid mixture, the liquid mixture can be efficiently permeated along the groove of the label fabric, thereby facilitating separation of the PET bottle and the label.

### DESCRIPTION OF DRAWINGS

FIG. 1 is a schematic view illustrating a label manufacturing apparatus according to the present disclosure.

FIG. 2 is a perspective view illustrating a release paper attaching unit in the label manufacturing apparatus according to the present disclosure.

FIG. 3 is a sectional view illustrating a label manufactured by the label manufacturing apparatus according to the present disclosure.

FIGS. 4 and 5 are plan views illustrating another embodiment of a label according to the present disclosure.

FIG. 6 is an image illustrating the label manufactured by the label manufacturing apparatus according to the present disclosure.

FIG. 7 is an image illustrating a roller of the release paper attaching unit in the label manufacturing apparatus according to the present disclosure.

### BEST MODE

Hereinafter, an exemplary embodiment of the present disclosure will be described in detail with reference to the accompanying drawings.

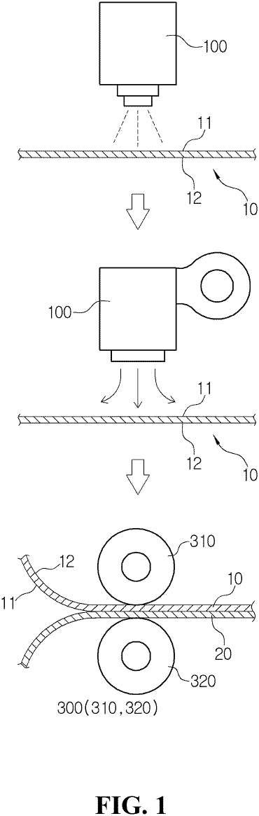

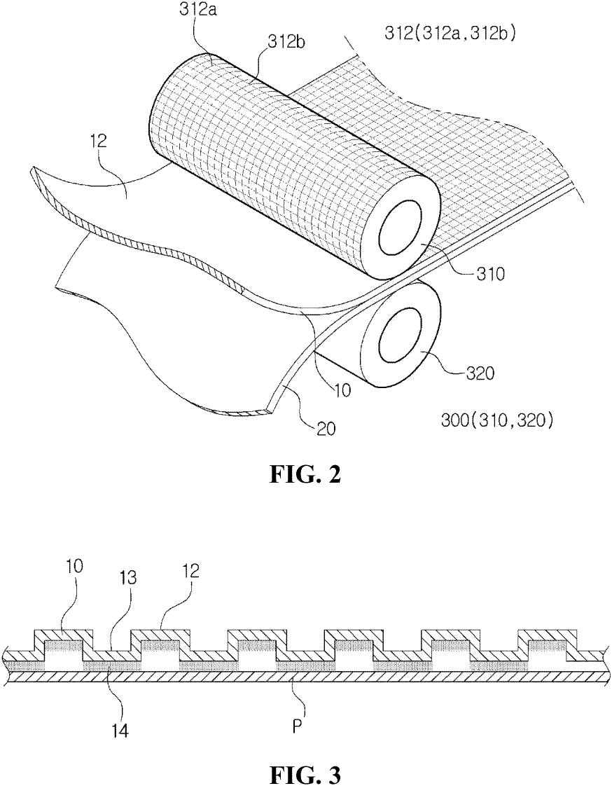

FIG. 1 is a schematic view illustrating a label manufacturing apparatus according to the present disclosure. FIG. 2 is a perspective view illustrating a release paper attaching unit in the label manufacturing apparatus according to the present disclosure. FIG. 3 is a sectional view illustrating a label manufactured by the label manufacturing apparatus according to the present disclosure.

Referring to the drawings, the label manufacturing apparatus according to the present disclosure includes a pressure-sensitive adhesive applying unit 100 applying a pressure-sensitive adhesive 14 onto a rear surface 11 of a label fabric 10, a pressure-sensitive adhesive drying unit 200 located behind the pressure-sensitive adhesive applying unit 100 and drying the pressure-sensitive adhesive 14 applied onto the rear surface 11 of the label fabric 10, and the release paper attaching unit 300 provided behind the pressure-sensitive adhesive drying unit 200 and attaching a release paper 20 onto the rear surface 11 of the label fabric 10.

In particular, in the present disclosure, as illustrated in FIG. 2, the release paper attaching unit 300 laminating the label fabric 10 and the release paper 20 is composed of a pair of rollers arranged at upper and lower positions. Among the pair of rollers, a roller guiding the label fabric 10 has a concave/convex portion 312 formed on a surface thereof so that a groove 13 is formed in the label fabric 10 passing through the release paper attaching unit 300 and laminated with the release paper 20.

In detail, a manufacturer, a manufacturing date, ingredients, a product name, etc. of a PET bottle P to which the label fabric 10 will be attached are printed on a front surface 12 of the label fabric 10, and the pressure-sensitive adhesive 14 is applied onto the rear surface 11 of the label fabric 10 so that it can be attached to the release paper 20 or the PET bottle P.

In other words, as illustrated in FIG. 1, the pressure-sensitive adhesive 14 is applied onto the rear surface 11 of the label fabric 10 by the pressure-sensitive adhesive applying unit 100. At this time, the pressure-sensitive adhesive applying unit 100 sprays the pressure-sensitive adhesive 14 on the rear surface 11 of the label fabric 10 by a spray method.

Furthermore, when the pressure-sensitive adhesive 14 is applied onto the rear surface 11 of the label fabric 10 as described above, the pressure-sensitive adhesive 14 applied onto the rear surface 11 of the label fabric 10 is dried by the pressure-sensitive adhesive drying unit 200. At this time, the pressure-sensitive adhesive drying unit 200 blows hot air to the rear surface 11 of the label fabric 10 to dry the pressure-sensitive adhesive 14 so as to have a predetermined viscosity.

As described above, when the pressure-sensitive adhesive 14 is applied onto the label fabric 10 and dried to have the predetermined viscosity, the release paper 20 is laminated on the rear surface 11 of the label fabric 10 by the release paper attaching unit 300. At this time, the release paper attaching unit 300 forms the groove 13 in the label fabric 10 laminated with the release paper 20.

As described above, when the groove 13 is formed in the label fabric 10, as illustrated in FIG. 3, a protrusion and a depression are repeated on the rear surface 11 of the label fabric 10 corresponding to the opposite side of the groove 13 formed in the label fabric 10, i.e., a portion to which the pressure-sensitive adhesive 14 is applied.

As the protrusion and the depression are repeated on the rear surface 11 of the label fabric 10, the protrusion is adhered to a surface of the PET bottle P, whereas the depression is not adhered to the PET bottle P but forms an empty space. Therefore, when a collected PET bottle is put in a liquid mixture for separating the PET bottle P and the label, the liquid mixture is permeated into the depression so that the PET bottle P and the label can be easily separated from each other.

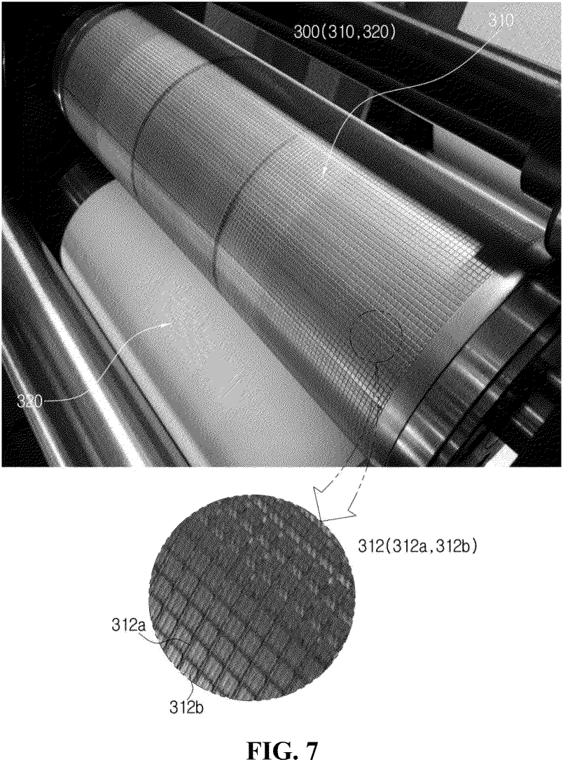

As illustrated in FIGS. 2 and 7, the release paper attaching unit 300 forming the groove 13 in the label fabric 10 so that the liquid mixture can be efficiently permeated into the label fabric 10 as described above has a structure in which a first roller 310 guiding the label fabric 10 and a second roller 320 guiding the release paper 20 in a state adjacent to the first roller 310 are arranged at upper and lower positions.

In this case, the first roller 310 has the concave/convex portion 312 formed on a surface thereof, and the second roller 320 has a flat surface. When the label fabric 10 and the release paper 20 are fed between the first roller 310 and the second roller 320 and laminated, the label fabric 10 is pressed against the concave/convex portion 312 formed on the first roller 310 to form the groove 13 in the label fabric 10 as illustrated in FIGS. 3 and 6.

Furthermore, as the second roller 320 has the flat surface, the release paper 20 is laminated with the label fabric 10 having the groove 13 in a flat state to prevent the label fabric 10 from being shrunk by the groove 13.

As described above, the first roller 310 forming the groove 13 in the label fabric 10 has the concave/convex portion 312 on the surface thereof as illustrated in FIGS. 2 and 7. When the label fabric 10 and the release paper 20 are fed between the first roller 310 and the second roller 320 so as to be laminated together, the concave/convex portion 312 provided on the first roller 310 presses the label fabric 10.

The concave/convex portion 312 formed on the first roller 310 includes a first slit 312a formed along a rotating direction of the first roller 310 and a second slit 312b formed along an axial direction of the first roller 310 by crossing the first slit 312a.

In this case, each of the first slit 312a and the second slit 312b formed in the first roller 310 extends from a first side edge to a second side edge of the label fabric 10 so that grooves 13 are formed over the entire area of the label fabric 10.

As described above, as the concave/convex portion 312 formed on the first roller 310 is composed of the first slit 312a and the second slit 312b and the first slit 312a and the second slit 312b are formed to cross each other, the grooves 13 through which the liquid mixture is permeated into the label fabric 10 are formed to cross each other. Therefore, when the PET bottle P cut into chips is put into the liquid mixture to remove the label, the liquid mixture is efficiently permeated along the grooves 13, thereby allowing the label fabric 10 and the PET bottle P to be efficiently separated from each other.

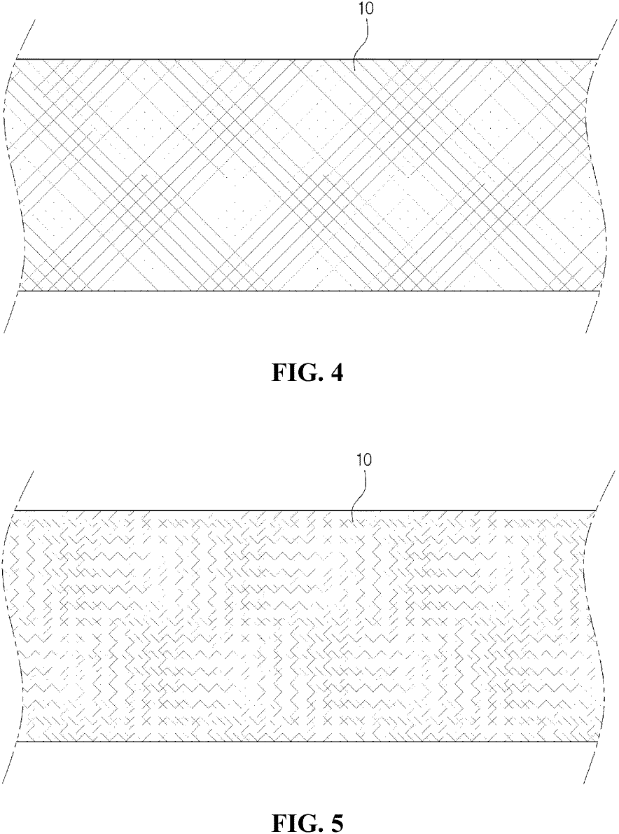

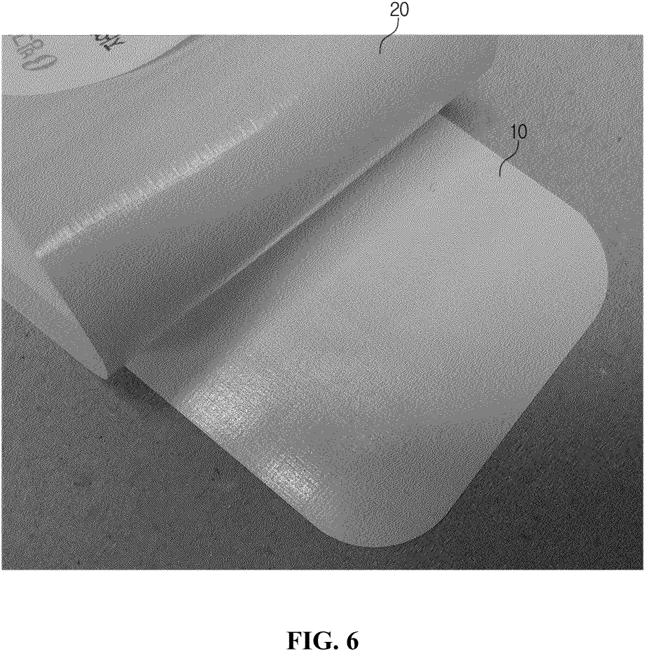

Meanwhile, as illustrated in FIGS. 4 and 5, the concave/convex portion 312 formed on the first roller 310 may be configured such that the first slit 312a and the second slit 312b cross each other in a diagonal pattern, and alternatively, the first slit 312a and the second slit 312b cross each other in a zigzag pattern.

The pattern of the first slit 312a and the second slit 312b may be variously modified and implemented as long as it is a pattern that enables the liquid mixture to be efficiently permeated into the label fabric 10 to allow the label fabric 10 to be efficiently separated from the PET bottle P.

According to the label manufacturing apparatus according to the present disclosure having the configuration as described above, since the groove 13 is formed in the label fabric 10 in the process of laminating the label fabric 10 with the release paper 20, it is possible to control the degree to which the label fabric 10 is adhered to the surface of the PET bottle P by the pressure-sensitive adhesive 14. Furthermore, when the PET bottle P collected for label separation is put in the liquid mixture, the liquid mixture is efficiently permeated along the groove 13 of the label fabric 10, thereby facilitating separation of the PET bottle P and the label.

Although the present disclosure has been described hereinabove with reference to an exemplary embodiment thereof, the present disclosure is not limited to the above-described exemplary embodiment. Therefore, various changes and modifications may be made without departing from the spirit and scope of the present disclosure and such changes and modifications belong to the claims of the present disclosure.

1. A label manufacturing apparatus comprising:
a pressure-sensitive adhesive applying unit configured to apply a pressure-sensitive adhesive onto a rear surface of a label fabric;
a pressure-sensitive adhesive drying unit located behind the pressure-sensitive adhesive applying unit and configured to dry the pressure-sensitive adhesive applied onto the rear surface of the label fabric; and
a release paper attaching unit provided behind the pressure-sensitive adhesive drying unit and configured to attach a release paper onto the rear surface of the label fabric,
wherein the release paper attaching unit is configured such that among a pair of rollers configured to allow the label fabric and the release paper to pass therebetween to be laminated, a roller configured to guide the label fabric has a concave/convex portion formed on a surface thereof so that a groove is formed on the laminated label fabric which has passed through the release paper attaching unit.

2. The label manufacturing apparatus of claim 1, wherein the release paper attaching unit comprises:
a first roller configured to guide the label fabric; and
a second roller configured to guide the release paper in a state adjacent to the first roller, wherein the first roller has the concave/convex portion formed on a surface thereof, and the second roller has a flat surface.

3. The label manufacturing apparatus of claim 2, wherein the concave/convex portion comprises:
a first slit formed along a rotating direction of the first roller; and
a second slit formed along an axial direction of the first roller by crossing the first slit.

4. The label manufacturing apparatus of claim 3, wherein at least one of the first slit and the second slit is formed in a zigzag pattern.

5. A label manufactured by the label manufacturing apparatus of claim 1.
